(19) United States
(12) Patent Application Publication
(10) Pub. No.: US 2025/0303533 A1
(43) Pub. Date: Oct. 2, 2025

(54) Tool Socket Insert

(71) Applicant: WG Tools LLC, Jefferson, WI (US)

(72) Inventors: Kevin Leix, Helenville, WI (US); Samuel J. Dacquisto, III, Jefferson, WI (US)

(21) Appl. No.: 18/620,324

(22) Filed: Mar. 28, 2024

(51) Int. Cl. B25B 23/10; B25B 13/06; B25B 21/00; B25B 23/00

(52) U.S. Cl. CPC B25B 23/108; B25B 13/065; B25B 23/0035; B25B 21/00

(57) ABSTRACT

A tool socket insert includes an insert body that may be inserted into a socket well of a tool socket to advantageously allow a user to hold nuts and bolts and other fittings at the end of the socket. The tool socket insert may include integrated and spaced-apart break-off features to permit one to break off a portion of the socket insert to achieve the desired length of the insert prior to insertion into the socket well.

### FIELD

Aspects of this invention relate generally to hand tools, such as socket wrenches that use tool sockets, and more specifically to an innovative insert for a tool socket.

### BACKGROUND

It is known that hand tools are a useful everyday item to help with various projects. One of those hand tools is a socket wrench with an attachable socket. The socket wrench is useful for engaging and turning fasteners such as nuts and bolts. It is known that socket wrenches and sockets used with the socket wrenches come in different shapes and configurations and are available to accommodate numerous fastener sizes, including metric and standard (imperial) sizes.

Traditional socket wrenches have mostly served well in various applications but often lack certain features that could improve their overall performance. For example, a mechanic who routinely uses a socket wrench with a detachable socket, desires to complete a task as efficiently and quickly as possible. A lot of the times, mechanics are flat rate meaning they get paid per the job/task. This means time is money in their field, and so the more efficient a mechanic can be, the more money the mechanic will make. Moreover, in many instances, having the right tool for the job can be very expensive. For very expensive tools, this can get a mechanic into financial problems quickly. For example, a high end set of sockets for a socket wrench may cost upwards of $1,000 if not more. And this is just one of many tools a mechanic needs to get the job done.

Additionally, problem solving is a skill a mechanic must have. Mechanics will run into many problems and issues each day that they have to overcome. One of the many issues is getting a nut or bolt started in tight spaces. Using a shallow socket with an extension is one way to get the nut or bolt started in a tight space. The problem, however, with a shallow socket is there is limited space for a long bolt to pass through before it bottoms out in the socket, resulting in the nut not being properly secured to the bolt. If a deep well socket is used in this situation, in some cases the bolt will push the nut to the bottom of the deep socket making it nearly impossible to get the nut started on the bolt, which is very undesirable.

It is known that some of the high end and very expensive tool brands sell deep well sockets that have a ledge or broach designed into the socket. An example of such socket is described in U.S. Pat. No. 7,523,688. This integrated ledge holds the nut toward the end of the socket to minimize the problem of the nut being pushed to the bottom. Most available sockets on the market, however, do not have these ledges built into their sockets, due to the high manufacturing costs associated with creating such a socket.

Other attempts to solve the known problems with deep well sockets is to use magnets within the socket well to try to hold the nut at the end of the socket. A major problem with the use of these magnets, however, is that they do not allow a long bolt to pass through it and into the deep well of the socket. This problem alone makes the use of magnets not practical.

The present invention addresses these and other known limitations and drawbacks with existing tools, such as socket wrenches and sockets, by incorporating novel features that enhance the functionality of the socket wrench while providing a more budget-friendly tool.

Particular objects and advantages of the present invention will be apparent to those skilled in the art, that is, those who are knowledgeable or experienced in this field of technology, in view of the following disclosure of the invention and detailed description of the embodiments.

### SUMMARY

Aspects of the present invention may be used to overcome the known problems with socket wrenches and the sockets used with those wrenches. In one aspect, the present invention provides an innovative socket well insert that will transform a budget set of sockets into a high end set. The socket well insert of the present invention is designed to fit nearly all sockets on the market.

In one aspect of the disclosure, the innovative tool socket insert is inserted into the well of the socket and advantageously allows the user to hold nuts, bolts, and zerk fittings at the top or end of the socket. This is very desirable for the reasons described above.

In an alternative aspect, the tool socket insert of the invention includes integrated break off features to permit one to break off a portion of the socket insert to achieve the desired length of the insert. This is achieved through step features or windows formed along the length of the socket insert at spaced apart locations to allow a number of different lengths of the socket insert to be created.

In another aspect of the invention, this break off of a portion of the socket insert may be achieved through the use of common pliers-one pliers may be used to grip around the socket insert and other pliers may grip the inside of the socket insert and together they are operated to simply break off a portion of the socket insert at the desired length. An alternative way to create the desired length of the socket insert is to use a utility knife. A user can place the socket insert on a hard surface, slide the utility knife blade into the step feature or window, and then simply press down on the utility knife to break the socket insert at the location of the step feature or window.

In an embodiment of the invention, once the desired length of the socket insert is achieved, a user can insert the socket insert into the socket, such as into a deep well socket. The insertion of the socket insert into the socket may be achieved by hand, or for those inserts that provide a tighter fit in the socket, a bench vise can be used. Once the socket insert is installed into the socket, it can remain in the socket for as long as the user desires for it to remain in the socket.

From the foregoing disclosure, it will be readily apparent to those skilled in the art, that is, those who are knowledgeable or experienced in this area of technology, that embodiments of the tool socket insert described in this disclosure may provide a significant technological advance over existing tools out on the market. These and additional features and advantages will be further understood from the following detailed disclosure of the preferred embodiments.

### BRIEF DESCRIPTION OF THE DRAWINGS

FIG. 1 is an isometric view of a socket with a socket insert according to aspects of the disclosure.

FIG. 2 is a side view of the socket of FIG. 1.

FIG. 3 is a section view taken along line A-A of FIG. 2 showing the socket insert according to aspects of the disclosure.

FIG. 4 is an isometric view of a socket insert according to aspects of the disclosure.

FIG. 5 is a side view of the socket insert of FIG. 4.

FIG. 6 is a side view of a broken off portion of the socket insert of FIG. 4.

FIG. 7 is a top view of the socket insert of FIG. 4.

FIG. 8 is a top view of the broken off portion of FIG. 6.

FIG. 9 is an exemplary socket wrench and the socket and socket insert according to aspects of the disclosure.

FIG. 10 is a side view of the socket wrench of FIG. 9.

FIG. 11 is an exemplary powered wrench and the socket and socket insert according to aspects of the disclosure.

FIG. 12 is a side view of the wrench of FIG. 11.

The figures referred to above are not drawn necessarily to scale and should be understood to provide a representation of an exemplary tool socket insert, illustrative of the principles involved. Some features of the socket insert depicted in the drawings have been enlarged or distorted relative to others to facilitate explanation and understanding. The same reference numbers are used in the drawings for similar or identical components and features shown in various alternative embodiments. The sockets and socket inserts as disclosed herein may have configurations and components determined, in part, by the intended application and environment in which they are used.

### DETAILED DESCRIPTION OF THE EMBODIMENTS

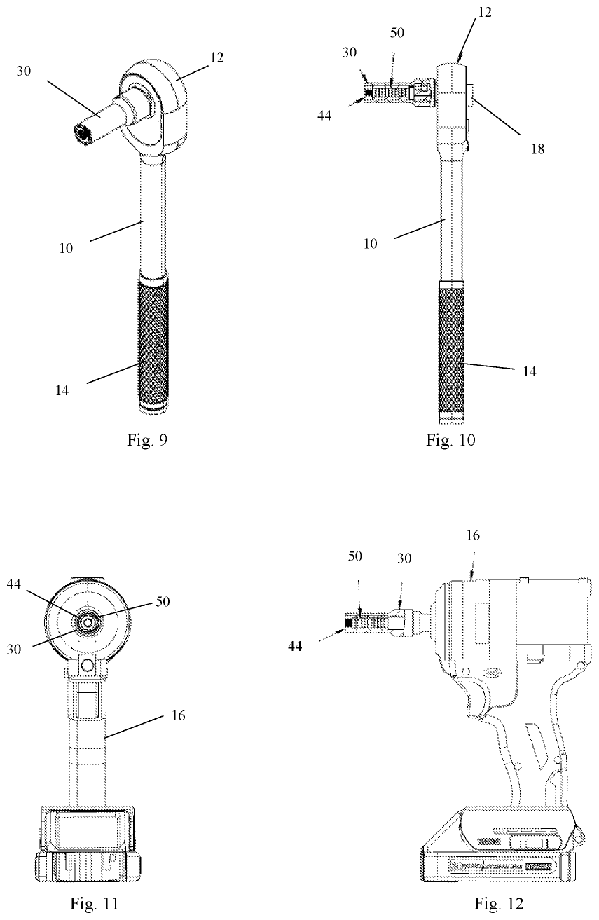

The present invention may be embodied in various forms. Referring to FIGS. 9-10, an exemplary socket wrench 10 is depicted. The socket wrench is known to define numerous shapes, sizes and configurations. The socket wrench may be a screwdriver style. It may also be a ratchet style. Referring to FIGS. 11-12, the wrench may also be a battery powered or air powered impact style 16.

The term “socket wrench” as used in this disclosure is meant to include all wrench styles, including the screwdriver style, ratchet style, battery or air powered impact style, and any other style.

In an exemplary embodiment, with some of the known socket wrench styles, the socket wrench may define a handle 14 at one end for the user to grip when using the wrench. The handle may define an ergonomic design to provide optimal comfort and control thereby reducing user fatigue during extended use of the socket wrench.

The socket wrench may define at an opposing end 12 a socket attachment. The socket attachment is used to detachably attach a socket 30 to the socket wrench. The socket may define numerous sizes and socket depths, as explained below. Typically, the socket attachment on the socket wrench defines a post or extension that further defines a cube shaped configuration. It typically further includes an integrated movable bearing that functions to hold the detachable socket to the post of the socket attachment, as understood in the art. The post or extension is typically one of a limited number of sizes to create a universal size for attachment of the sockets. This permits various sized sockets to be mounted to a single post size of the socket attachment.

It is known that some socket wrenches include a quick-release feature 18 to allow for a quick-release of the detachable socket 30 from the wrench 12 and therefore to permit rapid socket changes, enhancing efficiency during tasks and reducing downtime. Many socket wrenches and sockets are made of durable high-quality materials such as chrome-vanadium steel to ensure their durability and resistance to corrosion.

It is known that the socket is the component of the tool that engages with a fastener to permit the tool to either loosen or tighten the fastener. A socket operates by engaging the fastener, whether a bolt head or nut, and its grip surfaces contact opposing surfaces on the fastener. Once the socket engages the fastener, a user rotates the socket, whether manually or through battery powered or pneumatic assistance, and this rotation also rotates the engaged fastener to thereby allow one to tighten or loosen the fastener, as desired.

The socket may define a connection aperture that is sized and shaped to mate with the post on the socket wrench. The connection of the socket to the post on the socket wrench is a detachable connection and may include a quick-release feature, as understood in the art. The size of the aperture and mating post is sometimes referred to as the drive size of the tool. It is known that sockets come in different drive sizes, with the common options being ¼-inch, ⅜-inch, and ½-inch drives. The drive size corresponds to the size of the post of the socket attachment of the wrench.

Sockets are available in a variety of shapes, sizes and lengths to accommodate different fasteners. The size is often measured in both standard (imperial) and metric units to ensure compatibility with various nuts and bolts.

Sockets can define a recess or socket well for receiving the nut or bolt. The socket well may have different point configurations, such as a 6-point or 12-point configuration. These multi-point configurations provide more surface area contact with the fastener nut or bolt, thereby more effectively transferring the torque from the socket wrench to the fastener and also reducing the likelihood of rounding off of corners of the nut or bolt. Some sockets have a chamfered lead-in to the recess or socket well to help guide the socket onto the fastener and reduce the risk of slipping. As indicated, many sockets also include a quick-release mechanism, allowing for swift socket changes on the socket wrench to enhance efficiency during tasks.

Existing sockets have varying depths of the recess. The depth of a socket well refers to how deep a fastener can extend into the socket. Sockets are available in various depths to suit different applications and different lengths of fasteners. These depths may be shallow, for example the same dimension as the nut, or the depths may be much deeper. Sockets with a deep recess or well are often referred to as a deep well socket. As indicated above, the invention of the present disclosure provides a solution to the known problems with well sockets, in particular deep well sockets but may also provide a solution to problems associated with shallow well sockets.

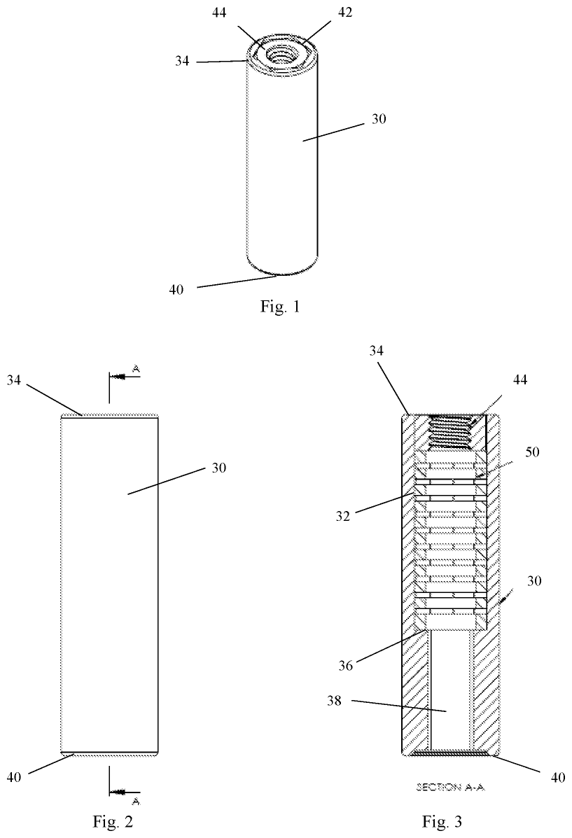

An exemplary socket 30 is depicted in FIGS. 1 and 2. The exemplary socket 30 may define an elongated cylindrical body having an axial length. As shown in FIG. 3, which provides a cross-section view of the socket 30, the exemplary socket may be a deep well socket. A deep well or recess 32 may extend from a first end 34 of the socket to an internal surface ledge 36 to form the well of the socket.

The socket 30 may further include a cylindrical through-hole or aperture 38 that extends from the ledge 36 to a second end 40 of the socket. In an exemplary aspect, the well 32 may define six sides 42 that create six points of contact for the fastener nut 44 and also create six points of contact for a socket insert 50, as described in further detail below.

As depicted in FIG. 3, and in an aspect of the invention, the socket insert 50 may be inserted into the well 32 and positioned on the ledge 36. Also positioned in the well is the fastener nut 44. As shown, and in an exemplary aspect of the invention, with the use of the socket insert 50, the fastener nut 44 is held at the first end 34 of the socket 30 to facilitate and improve the attachment of the nut to a bolt (not shown). The socket insert 50 defines a length that locates the nut 44 to a position at the end of the socket, which is desirable for properly attaching the nut to the bolt and which overcomes the problems with existing deep well sockets. In an exemplary aspect, the socket insert may be positioned in the socket well and on the socket well ledge 36 and may define a socket insert length that permits a fastener nut to be located at an end of the socket. A fastener bolt may threadedly attach to the fastener nut and may also pass through the central through-hole of the socket insert body as the nut is tightened onto the fastener bolt.

FIG. 3 shows the fastener nut 44 located at the first end 34 of the socket, after the socket insert 50 is positioned within the well 32 of the socket 30 and between the ledge 36 and the nut 44, thereby locating the nut to the first end 34 of the socket. As shown FIG. 1, the nut 44 can be seen to engage the six sides 42 of the socket well.

The socket insert 50 may be insertable and retractable from the socket 30. The socket insert 50 may be inserted by hand into the socket 30 or press fit into the socket using a bench vise or the like.

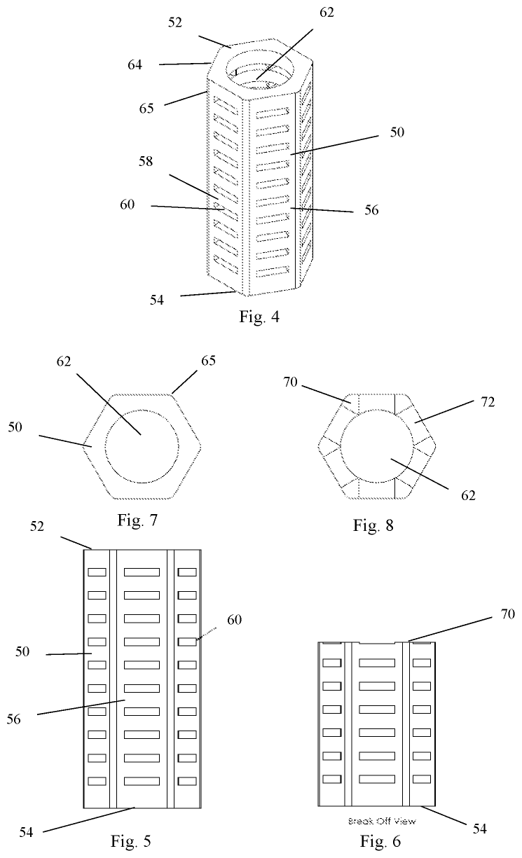

An exemplary embodiment of the socket insert 50 of the invention is further shown in FIGS. 4-8. The socket insert 50 may include a first end 52 and a second end 54. It may also define a socket insert body 56 that comprises one of more socket insert portions 58 that are defined and bordered by apertures or windows 60. The apertures or windows 60 extend through planar sides 64 of the body 56 from the exterior wall of the sides and into a through-hole or aperture 62 formed within the socket insert body 56.

The through-hole or aperture 62 extends longitudinally through the central axis of the socket insert 50 from the first end 52 to the second end 54. The aperture 62 defines a diameter of sufficient size that permits a bolt to pass through the aperture 62 from the first end 52 to the second end 54 of the socket insert 50. Similar to the nut, the socket insert 50 may define six planar sides 64 that are sized and shaped to match and mate with the internal six sides 42 of the socket well 32. It should be understood that the number of planar sides 64 may vary from more than six sides to less than six sides. For example, in an embodiment, the socket insert 50 may define 12 sides. The sides 64 may be joined at the edges 65 of the sides. The edges may be rounded or chamfered to facilitate insertion of the socket insert 50 into a socket well.

In an exemplary aspect, the apertures or windows 60 that are spaced apart longitudinally along the length of the socket insert serve as locations to break off or cut away portions 58 of the socket insert to achieve the desired length of the socket insert. As depicted, numerous apertures or windows 60 may be placed along the length of the socket insert and at any desired spacing to permit various lengths of the socket insert to formed. In an embodiment, the apertures or windows are spaced evenly along the length of each planar side and are located at the same distances on each side as measured from the end of the socket body, as shown in FIG. 5. in an exemplary aspect, FIG. 6 depicts a broken off portion 70 of the socket insert 70 and, as depicted, is much shorter in length than the socket insert 50 depicted in FIG. 5. In an embodiment of the socket insert, multiple lengths of a broken off portion 70 may be formed from a single socket insert 50 to create multiple socket inserts.

FIG. 8 depicts an end view of the broken off portion 70 and shows the surfaces 72 which were part of the windows 60. Also depicted is the aperture 62 through which may pass the fastener bolt.

As indicated, the break off of portions of the socket insert may be achieved through the use of common pliers. One pliers may be used to grip around the socket insert and other pliers may grip the inside of the socket insert and together they are used to break off portions of the socket insert at the desired location to create the desired length.

The second way to create the desired length of the socket insert is to use a utility knife, whereby a user can place the socket insert on a hard surface, slide the utility knife blade into the window 60, and then press down on the utility knife to break the socket insert at that location.

Under either technique, and once the desired length of the socket insert is achieved, a user can insert the socket insert 50 into the well 32 of the socket, either by hand, or by press fitting it with the use of a bench vise. Once inserted, socket insert 50 can remain in the socket 30 for as long as the user desires for it to remain in the socket.

It is to be appreciated that the socket insert may be made from a variety of materials, such as any number of thermoplastics or polymers, that permit the formation of the socket insert and also permit the break-away features of the socket insert. The socket insert may be formed through any known forming technique, including injection molding, thermoplastic molding, casting, plastic fabrication, die casting, additive manufacturing (3D printing), and the like. It should be understood that other materials may be used to form the socket insert, including through the use of metals, alloys, woods, or other formed materials.

As indicated, the socket insert may be used for numerous applications requiring a variety of types of sockets. The socket insert is the solution to the problem with long bolts or hard to reach locations where a deep well socket is needed but where the nut needs to be positioned at the end of the socket in order for it to be fastened to the bolt. As indicated, after the socket insert is inserted into the deep well socket it advantageously allows the user to hold nuts, bolts, and zerk fittings at the end of the socket.

Various embodiments of a tool socket insert have been described herein, which include various components and features. In other embodiments, the socket insert may be provided with any combination of such components and features. It is also understood that in other embodiments, the various devices, components, and features of the socket insert described herein may be constructed with similar structural and functional elements having different configurations, including different ornamental appearances.

Those having skill in the art, with the knowledge gained from the present disclosure, will recognize that various changes can be made to the disclosed apparatuses and methods in attaining these and other advantages, without departing from the scope of the present disclosure. As such, it should be understood that the features described herein are susceptible to modification, alteration, changes, or substitution. For example, it is expressly intended that all combinations of those elements and/or steps which perform substantially the same function, in substantially the same way, to achieve the same results are within the scope of the embodiments described herein. Substitutions of elements from one described embodiment to another are also fully intended and contemplated. The specific embodiments illustrated and described herein are for illustrative purposes only, and not limiting of that which is set forth in the appended claims. Other embodiments will be evident to those of skill in the art. It should be understood that the foregoing description is provided for clarity only and is merely exemplary. The spirit and scope of the present disclosure is not limited to the above examples, but is encompassed by the following claims.

What is claimed is:

1. An insert for a tool socket, comprising:
an elongated socket insert body further defining:
a first end,
an opposing second end,
a central through-hole extending from the first end to the second end,
a plurality of planar sides that form an exterior of the socket insert body, and
a plurality of spaced-apart apertures located on the plurality of sides, the spaced-apart apertures extending from the planar sides to the central through-hole, wherein the spaced-apart apertures serve as locations to permit the cutting of the socket insert body at the location of the aperture.

2. The insert of claim 1, wherein the plurality of planar sides are six sides that are each joined at side edges to form a six-sided insert body.

3. The insert of claim 2, wherein each of the six planar sides define a plurality of space-apart apertures.

4. The insert of claim 3, wherein the central through-hole has a uniform diameter from the first end to the second end.

5. The insert of claim 1, wherein the tool socket defines a socket well ledge, and wherein either of the first or second end of the socket insert body is positioned on the socket well ledge.

6. The insert of claim 5, wherein the socket insert body positioned on the socket well ledge defines a length that permits a fastener nut to be located at an end of the tool socket.

7. The insert of claim 6, wherein the fastener nut is held at the end of the tool socket by the socket insert body.

8. The insert of claim 7, wherein a fastener bolt threadedly attaches to the fastener nut and also passes through the central through-hole of the socket insert body.

9. The insert of claim 1, wherein the socket insert body is positioned within a socket well of the tool socket such that a fastener nut is located at an end of the tool socket.

10. The insert of claim 9, wherein a fastener bolt threadedly attaches to the fastener nut and also passes through the central through-hole of the socket insert body.

11. The insert of claim 10, wherein the socket insert body is breakable into one or more socket insert body portions.

12. A socket wrench that includes the tool socket and socket insert body of claim 1.

13. A powered wrench that includes the tool socket and socket insert body of claim 1.

14. A socket wrench comprising:
a wrench handle at a first end,
a socket attachment at a second end;
a detachable socket mounted to the socket attachment at the second end;
a socket insert located within the detachable socket, the socket insert further comprising:
an elongated socket insert body further defining:
a first end,
an opposing second end,
a central through-hole extending from the first end to the second end,
a plurality of planar sides that form an exterior of the socket insert body, and
a plurality of spaced-apart apertures located on the plurality of sides, the spaced-apart apertures extending from the planar sides to the central through-hole, wherein the spaced-apart apertures serve as locations to permit the cutting of the socket insert body at the location of the aperture.

15. The socket wrench of claim 14, wherein the detachable socket defines a socket well and a ledge within the socket well, and wherein either of the first or second end of the socket insert body is positioned on the socket well ledge.

16. The socket wrench of claim 15, wherein the socket insert body positioned on the socket well ledge defines a length that permits a fastener nut to be located at an end of the detachable socket.

17. The socket wrench of claim 16, wherein a fastener bolt threadedly attaches to the fastener nut and also passes through the central through-hole of the socket insert body.

18. A powered wrench comprising:
a wrench body and a socket attachment located on the wrench body;
a detachable socket mounted to the socket attachment;
a socket insert located within the detachable socket, the socket insert further comprising:
an elongated socket insert body further defining:
a first end,
an opposing second end,
a central through-hole extending from the first end to the second end,
a plurality of planar sides that form an exterior of the socket insert body, and
a plurality of spaced-apart apertures located on the plurality of sides, the spaced-apart apertures extending from the planar sides to the central through-hole, wherein the spaced-apart apertures serve as locations to permit the cutting of the socket insert body at the location of the aperture.

19. The powered wrench of claim 18, wherein the detachable socket defines a socket well and a ledge within the socket well, and wherein either of the first or second end of the socket insert body is positioned on the socket well ledge.

20. The powered wrench of claim 19, wherein the socket insert body positioned on the socket well ledge defines a length that permits a fastener nut to be located at an end of the detachable socket, and wherein a fastener bolt threadedly attaches to the fastener nut and also passes through the central through-hole of the socket insert body.
